(19) United States
(12) Patent Application Publication
(10) Pub. No.: US 2022/0408716 A1
(43) Pub. Date: Dec. 29, 2022

(54) AUGMENTED RODENT TRAP DEVICE AND METHOD OF USE

(71) Applicant: Michael McGrade McGrade, West Covina, CA (US)

(72) Inventor: Michael McGrade McGrade, West Covina, CA (US)

(21) Appl. No.: 17/877,777

(22) Filed: Jul. 29, 2022

Related U.S. Application Data
(63) Continuation-in-part of application No. 17/362,035, filed on Jun. 29, 2021, now Pat. No. 11,445,719.

(51) Int. Cl. A01M 23/30; A01M 23/00

(52) U.S. Cl. CPC A01M 23/30; A01M 23/005

(57) ABSTRACT

A removeable, adhesive pad sticker used to augment any existing rodent trap by affixation to the top face of the rodent trap. It has an adhesive pad facing up in the region of the bait station. When the rodent steps on it and stops to take the bait, they are no longer capable of quickly moving when they activate the trap's trigger and the kill bar of the rodent trap is released. Even if the rodent does not reach the bait station, their jiggling efforts to extricate their feet and/or lower body from the adhesive wrapper will activate the trigger. This addition to a snap trap raises the kill ratio to approximately 100% but more importantly, allows the kill bar to strike the rodent behind the neck eliminating any unsightly mess.

### CROSS-REFERENCE TO RELATED APPLICATIONS

### Priority Claim to a Nonprovisional Application

THIS APPLICATION IS A CONTINUATION OF U.S. PATENT APPLICATION SER. NO. 17/362,035, FILED JUN. 29, 2021, WHICH IS INCORPORATED BY REFERENCE HEREIN IN ITS ENTIRETY.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to rodent traps, and more particularly to the technology of augmenting existing rodent traps.

### BACKGROUND

The first rodent trap was patented in 1894 by an American inventor named William C. Hooker. It's patented “snap trap” embodiment is still the largest selling rodent trap on the market. However, rodents are much harder to catch than one would think. This is especially true if the rodent has encountered that same trap before. There are a plethora of ways by which a rodent can escape a trap and still get the bait. Since their reflexes are extremely quick, any movement or sound from a trap elicits an upward or backward hop by the rodent, keeping them away from the wound spring driven strike bar. Simply stated, if rodents were easy to catch in the existing conventional snap traps, there would not continue to be a stream of new rodent traps introduced to the market each year.

The problem is that the rodent must be free to approach the bait station part of the trap and get positioned under the strike bar yet not be free to move away or hop out of the circular path of the strike bar once they are correctly positioned. With other traps such as glue pad traps, the rodent is sufficiently retained by its feet, yet will chew their appendages off to escape — which is far from a humanitarian way to eradicate them. Lastly, the kill of a rodent on a common snap trap often has the kill bar strike the rodent mid body making a mess of projected rodent feces and entrails. These are the quandaries.

Henceforth, an augmented rodent trap that prevents the rodent from escaping the strike bar and does not make a messy kill, would fulfill a long felt need in the industry. This new invention utilizes and combines known and new technologies in a unique and novel configuration to overcome the aforementioned problems and accomplish this.

### BRIEF SUMMARY

In accordance with various embodiments, an augmented rodent trap that retains the rodent on the trap before the trap's activation is provided.

In one aspect, a replaceable augmentation device that can be adapted to, or directly mated to most rodent traps.

In another aspect, an inexpensive, humane trap for the eradication of rodents that dramatically raises the kill ratio per rodent/trap encounter.

In another aspect a rodent trap that eliminates or minimizes the mess of killing a rodent by targeting the rodent's neck as the strike zone.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is a top perspective view of a snap trap with an adhesive pad sticker thereon;

FIG. 2 is a side cross sectional view of the first embodiment adhesive pad sticker;

FIG. 3 is a side cross sectional view of the second embodiment adhesive pad sticker;

FIG. 4 is a side cross sectional view of the third embodiment adhesive pad sticker;

FIG. 5 is a side cross sectional view of the fourth embodiment adhesive pad sticker;

FIG. 6 is a side cross sectional view of the fifth embodiment adhesive pad sticker;

FIG. 7 is a top view of the first to fifth embodiment adhesive pad stickers;

FIG. 8 is a bottom view of the first to fifth embodiment adhesive pad stickers;

FIG. 9 is a bottom view of a sixth embodiment trap adhesive wrapper;

FIG. 10 is a side view of the sixth embodiment trap adhesive wrapper;

FIG. 11 is a top perspective view of the sixth embodiment trap adhesive wrapper installed on a snap trap; and

FIG. 12 is a bottom perspective view of the sixth embodiment trap adhesive wrapper installed on a snap trap.

### DETAILED DESCRIPTION OF CERTAIN EMBODIMENTS

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

Reference will now be made in detail to embodiments of the inventive concept, examples of which are illustrated in the accompanying drawings. The accompanying drawings are not necessarily drawn to scale. In the following detailed description, numerous specific details are set forth to enable a thorough understanding of the inventive concept. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” “connected to,” “affixed thereon” or “affixed thereto” another element or layer, it can be directly on, indirectly on, directly coupled to, indirectly coupled to, directly connected to or indirectly coupled to, affixed directly thereon or affixed indirectly thereon, affixed directly thereto or affixed indirectly thereto the other element or layer. Thus, intervening elements or layers may be present in the structure. As used herein, the term “and/or” includes any and all combinations of one or more of the associated listed items.

The terminology used in the description of the inventive concept herein is for the purpose of describing particular embodiments only and is not intended to be limiting of the inventive concept. As used in the description of the inventive concept and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

In the following description, for the purposes of explanation, numerous specific details are set forth in order to provide a thorough understanding of the described embodiments. It will be apparent to one skilled in the art, however, that other embodiments of the present invention may be practiced without some of these specific details. It should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers herein used to express quantities, dimensions, and so forth, should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

As used herein, the term “rodent” refers to mice, rats, moles, voles, squirrels and other animals characterized by a single pair of continuously growing incisors in each of their upper and lower jaws.

As used herein, the term “snap trap” refers to a type of spring loaded trap that releases a kill bar under torsional force that strikes the rodent across the body with enough force to snap the rodent's neck or torso instantly killing them.

As used herein the terms “adhesive bottom pad” and “adhesive element” are interchangeable and refers to double sided tape as well as adhesive pads.

The present invention relates to a novel design for a device that may be added to augment any rodent trap to enhance the percentage of eradication of the rodent. It will be marketed and sold both affixed thereon a snap trap, and as a stand-alone adhesive pad sticker to be affixed to a snap trap. Basically, it retains the rodent in the “zone of strike” of the kill bar once it has entered the bait station portion of the trap by adding a removeable adhesive pad sticker to the rodent trap bait area. When the rodent walks onto the adhesive pad sticker and stops at the bait station area, they are unable to release their feet. They will either touch the bait and activate the trigger or try to remove their feet and jiggle the trap enough to release the kill bar. With their feet riveted to the top of the trap, they can't get away from the kill bar. Rodents have very quick reflexes and often jump up and out of the way of the kill bar when the sound or vibration that occurs when the kill bar latching mechanism releases. This has led to the unexpected result of achieving a 100% kill to visit ratio for rodents on a snap trap with the adhesive pad sticker vs just a snap trap. The kill ratio of rodents that make contract with a trap or glue pad alone is in the 50% to 65% range. When the glue pad sticker is affixed to a snap tap this kill ratio approaches 100%. In six months of field testing, there were no disturbed traps with adhesive pad stickers affixed thereto, that did not have a dead rodent thereon. It also prevents the inhumane deaths that rodents endure when trapped on just an adhesive pad alone. However, the second, and possibly more important unexpected result of the adhesive pad sticker, is that the adhesive pad sticker will prevent the splattering of rodent guts and feces onto the platform of the rodent trap because it keeps the rodent from advancing close enough to the bait station before their feet get stuck and the kill bar strikes them. This way the kill bar strikes them behind their head not center of their body and their necks are broken such that there are no guts or excrement exiting the corpse. Tests have confirmed the same kill ratio when the adhesive sticky pad is utilized with other rodent traps. This 100% kill ratio is essentially double that of traps without the adhesive pad.

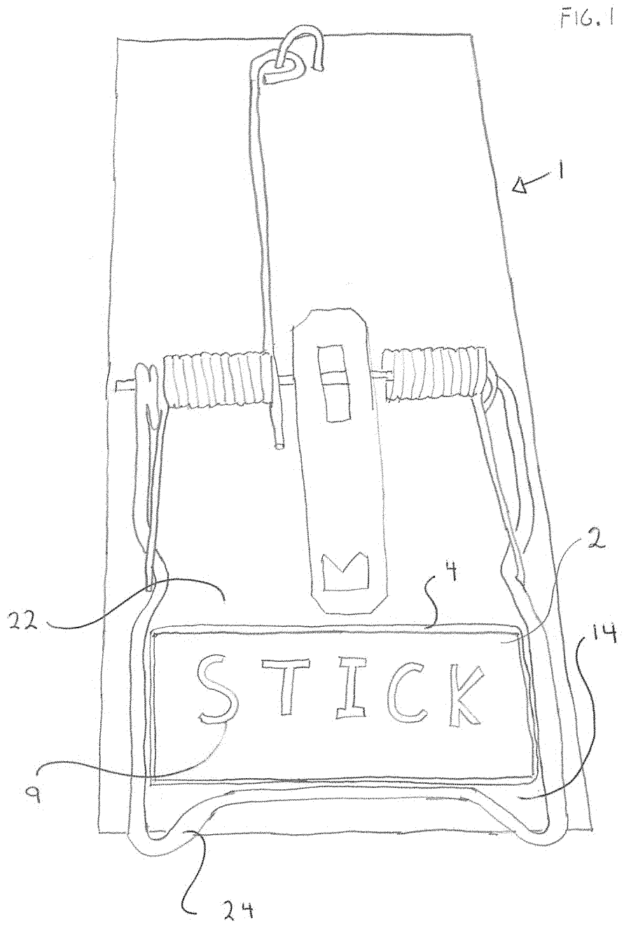

Looking at FIGS. 1, 2 and 7, it can be seen that the first five embodiments of the trap adhesive pad sticker 2, are rectangular, planar bodies, having a length (designated as dimension X) that exceeds its width (designated as dimension Y) and a thickness (designated as dimension Z) which varies depending on the fabrication method of bonding the adhesive surfaces to the substrate sheet 4.

The first five embodiments have five common elements. A central substrate sheet 4 (preferably of a card stock paper, cardboard, polymer or polymer coated paper), an adhesive top pad 6, an adhesive bottom pad 8, a top releasable sheet 10, a bottom releasable sheet 12, and a printed advertisement 9 on the top releasable sheet 10, or the adhesive top pad 6 (optionally, when the top releasable sheet is transparent.). All five of these embodiments function in the same way. Their bottom releasable sheet 12 is peeled off and the adhesive bottom pad 8 is pressed onto the top face 22 of the trap 1 (snap or otherwise) in the killing region 14 of the trap. The top release sheet 10 is then peeled off once the trap is set. There is an optional advertisement (textural or graphic) that is on the top releasable sheet 10 or the top adhesive pad 6.

What varies between the first to fifth different embodiments is the method of fabrication used to place the adhesive top pad 6 and adhesive bottom pad 8 onto the substrate sheet 4. The two areas of adhesive (the adhesive top pad 6 and adhesive bottom pad 8) may be sprayed, painted, rolled, calendared or pressed onto the top or bottom face of the substrate sheet 4. The adhesives may be applied in a liquid or gel glue form, or may be pressure applied if it is put on as a two sided adhesive pad or tape. There are a plethora of different adhesives and methods of applying the different adhesives onto the adhesive pad sticker 2. The critical feature of the adhesive is that it is sticky enough to hold a rodent on its outer surface.

It is to be noted that the adhesive of the adhesive top pad 6 and the adhesive bottom pad 8 may be identical or different adhesives. Generally, though, the adhesive top pad 6 will utilize a non-drying gel adhesive that has an optional scent 11 added to the adhesive. The depth of the adhesive and hence the tackiness will be adjusted for the type of rodent to be eliminated. Mouse trap adhesive pad stickers may utilize a shallower pad of top adhesive. This adhesive pad may be released with vegetable oil and is non-toxic to humans and pets.

These first and second adhesives may be also be made in a plethora of different types similarly to that of the area of adhesive 22, discussed herein. It is to be noted that in the preferred embodiment, both the areas of adhesive incorporate releasable sheets that must be removed prior to first use. These releasable sheets prevent the trap adhesive pad sticker 2 from sticking to anything it comes in contact with and allows groups of them to be packaged in a cost effective, close contact packaging. In alternate embodiments pressure sensitive adhesives may be utilized or two part contact adhesion regions may be used as is well known in the packaging industry.

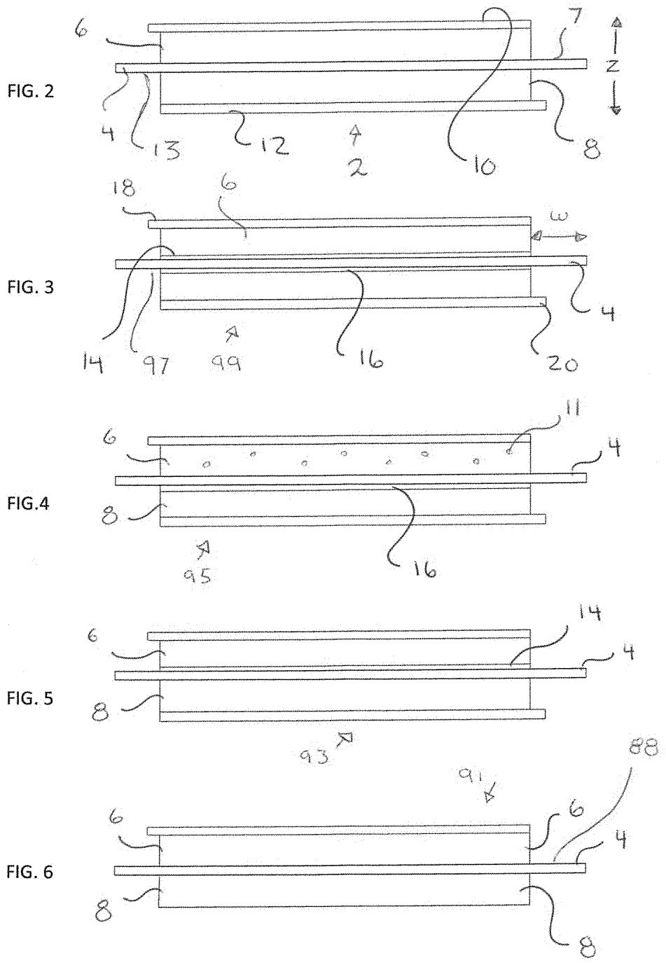

Looking at FIG. 2, it can be seen that the first embodiment adhesive pad sticker 2 has a planar substrate sheet 4 with a top adhesive pad 6 directly applied to the top face 7 of the substrate sheet 4. The top adhesive pad has a top releasable sheet 10 thereon, with a first optional release tab 18 that extends beyond some portion of the perimeter edge of the top adhesive pad 6. (See FIG. 7) This release tab allows the user a point to begin the removal of it from the adhesive pad 6. The bottom face 13 of the substrate sheet 4 has an adhesive element 8 affixed thereto in a similar fashion. It has a similar bottom releasable sheet 12 with a second optional release tab 20 extending beyond the perimeter edge of the second adhesive pad 8. (See FIG. 8) As can be seen the adhesive pad 6 and element 8 do not extend to the perimeter edges of the substrate sheet 4 such that there are substrate sheet borders 88 (FIG. 6) around the perimeters of the adhesive pad and adhesive element. These substrate sheet borders are common on all embodiments and are designated as that region of the substrate sheet shown as dimension W on FIG. 3 In this simple embodiment, the bottom adhesive element 8 may be double sided tape or a second adhesive pad.

This is the simplest structure of all embodiments, wherein, the first and second adhesive pads are first and second adhesives directly applied to the top and bottom faces of the substrate sheet. This may be accomplished by painting, spraying, or otherwise depositing and applying the liquid or gel adhesives thereon or applying the double sided tape. There is an optional printed advertisement 9 (FIG. 1) visible on the adhesive pad sticker 2. This may be printed on the top releasable sheet 10 or if the top release sheet 10 is transparent, the printed advertisement may be in the actual first adhesive. This advertisement attachment is common to all embodiments.

Looking at FIG. 3, it can be seen that the second embodiment adhesive pad sticker 99 has a planar substrate sheet 4 with a top adhesive pad 6 applied to the top face 7 of the substrate sheet 4. The top adhesive pad also has a top releasable sheet 10 thereon, with a first optional release tab 18 that extends beyond some portion of the perimeter edge of the top adhesive pad 6 as in the first to fifth embodiments. Here, the first adhesive of the top adhesive pad is affixed to a top contact sheet 14 that is affixed to the top face 7 of the substrate sheet 4. This attachment of the top adhesive pad 6 to the substrate sheet 4 is by the affixation of the top contact sheet 14 to the top face of the substrate sheet and may be by mechanical means such a stapling, or most preferably, by another adhesive means that has been applied to the bottom face of the top contact sheet 14. This adhesive means may be pressure sensitive or pressure activated as is well known in the sticker industry.

Similarly, in the second embodiment adhesive sticker 99, the second adhesive of the adhesive bottom pad 8 is affixed to a bottom contact sheet 16 that is affixed to the bottom face 97 of the substrate sheet 4. This attachment of the adhesive bottom pad 8 to the substrate sheet 4 is by the affixation of the bottom contact sheet 16 to the bottom face of the substrate sheet 4 and may be by mechanical means such a stapling, or most preferably, by another adhesive means that has been applied to the top face of the bottom contact sheet 16. In this method of construction there are three separate elements that are stuck together by the release of two contact sheets 14 and 16 to create the adhesive pad sticker 2.

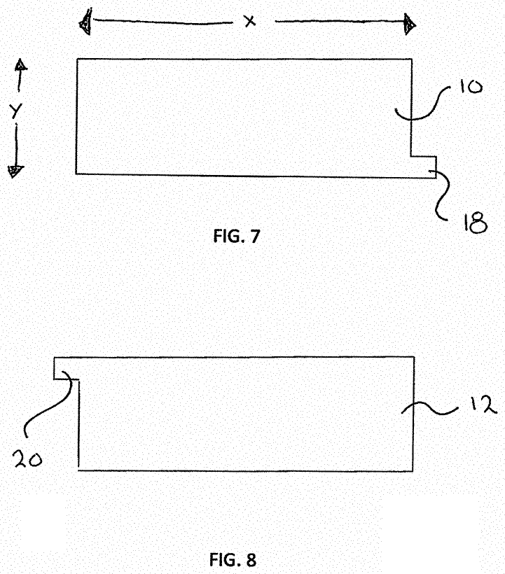

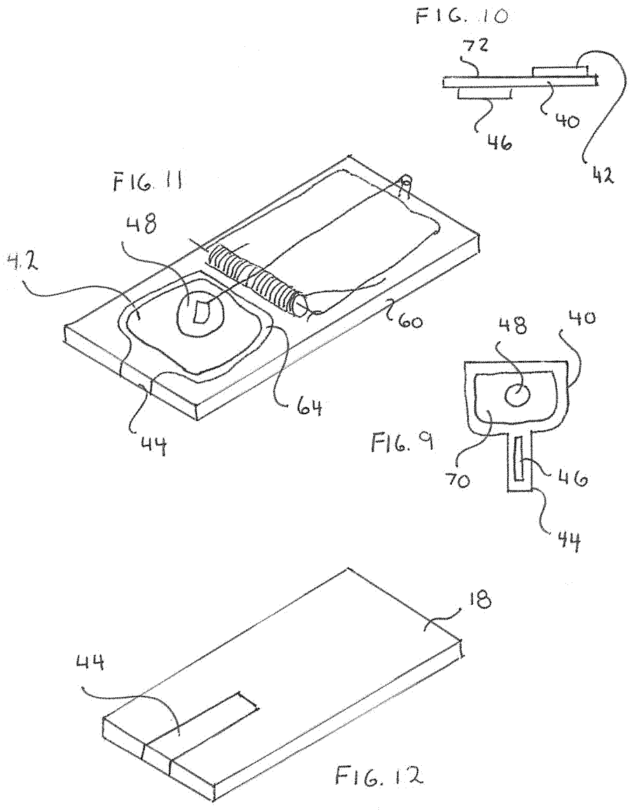

The third embodiment adhesive pad sticker 95 is best seen in FIG. 4. Here, in the first adhesive is a bait scent 11 chemical mixed with the first adhesive that attracts rodents. This bait scent is an optional addition that may be incorporated into any of the embodiments discussed herein. This third embodiment 95 is a hybrid of the first and second embodiments wherein the adhesive top pad 6 of the first embodiment and the adhesive bottom pad 8 of the second embodiment are affixed to the substrate sheet 4.

The fourth embodiment adhesive pad sticker 93 is best seen in FIG. 5. Here, this fourth embodiment 93 is a hybrid of the first and second embodiments wherein the adhesive top pad 6 of the second embodiment and the adhesive bottom pad 8 of the first embodiment are affixed to the substrate sheet 4.

The fifth embodiment 91 as seen in FIG. 6 is similar to the first embodiment 2 except the adhesive bottom pad 8 has no releasable bottom sheet 12 because the adhesive bottom pad 8 is a pressure activated adhesive pad.

As can be seen the adhesive pads 6 and 8 do not extend to the perimeter edges of the substrate sheet 4 such that there are substrate sheet borders around the perimeters of the adhesive pads. These substrate sheet borders are common on all embodiments and are designated as that region of the substrate sheet shown as dimension W on FIG. 3. These borders allow for a margin of error in the application of the adhesive top pad and the adhesive bottom pad onto the substrate sheet 4. This prevents the overlap of glue which could affix all of the adjacent stickers to each other in their packaging, potentially rendering the group of stickers useless, or at least, messy to handle.

From the side views of FIGS. 2-6, it can be seen that the adhesive top and bottom pads do not extend to the edge of the substrate sheet 4 but rather leave a narrow non-sticky alley 88 about all sides of the perimeter of both of these adhesive pads. This is for three reasons: to allow a margin of error in the placement of the areas of adhesive, to give the rodent a small non-sticky region to place their forward feet onto the trap before leaping up onto the trap 1 with all four feet and their body, where all four feet and underbelly become stuck to the top plate 4 and cementing them with their neck under a kill bar to eliminate messy kills, and to allow the user to pick up and place the rodent trap without their fingers curling slightly about the sides of the trap and contacting the adhesive. Test have shown that if the area of adhesion extends to the edge of the substrate sheet 4, the rodent will only get one foot onto the trap before realizing it is stuck and proceed no further.

FIGS. 9-12 show a sixth embodiment trap adhesive wrapper 40. This style is developed for use with only the common snap trap 60. Its adhesive pad design differs from that of the first five embodiments in that it is designed to wrap around the base plate of the snap trap 60 and affix to the bottom side of it. Here, there is a generally rectangular, adhesive region 42 formed on the second substrate sheet 72. The second substrate sheet 72 has a linear tail wing 44 with a third adhesive 46 on its back face. The tail wing 44 extends from one of the four sides of the second substrate sheet 72. The adhesive region 42 has an orifice 48 defined therein that goes around the bait/trigger mechanism of the snap trap 60. Similar to the preferred embodiment trap adhesive wrapper 2, there is a second non-sticky peripheral alley 64 around all four sides of the adhesive region 42. There may be an optional fourth adhesive 70 on the back face of the substrate sheet 40 to hold it to the top face of the snap trap 60. Since the cost of a snap trap is so low, studies show people do not try to reuse them after a rodent has been eradicated and thus there is little incentive to make each of the second embodiment trap adhesive wrappers replaceable.

Although the above disclosure presents the present invention as fabricated with the most cost effective methods, it is known that there could be an adhesive region directly applied to the top face of the trap by spraying, painting, calendaring etc. In this type of fabrication, the adhesive gel pad does not reside atop a substrate sheet, however still requires a top release sheet.

The simplified method of use follows the following steps:

Remove the bottom releasable sheet, if provided on that embodiment.

Position the adhesive pad sticker onto the top face of the rodent trap.

Apply pressure to ensure the adhesive pad sticker is firmly affixed to the trap.

Bait the trap.

Remove the releasable top sheet from said adhesive region.

Place trap in the desired trap region.

While certain features and aspects have been described with respect to exemplary embodiments, one skilled in the art will recognize that numerous modifications are possible. Moreover, while the procedures of the methods and processes for building, attaching and using the rodent trap augmentation device described herein are described in a particular order for ease of description, unless the context dictates otherwise, various procedures may be reordered, added, and/or omitted in accordance with various embodiments. Consequently, although several exemplary embodiments are described above, it will be appreciated that the invention is intended to cover all modifications and equivalents within the scope of the following claims.

Having thus described the invention, what is claimed as new and desired to be secured by Letters Patent is as follows:

1. An adhesive pad sticker for the affixation to a rodent trap to enhance the probability of eliminating a rodent while minimizing the probability of a messy kill, comprising:
a planar substrate sheet having a top face, a bottom face and a perimeter edge, where planar substrate sheet is selected from the set of substrate sheets including, polymer, paper and card stock sheets;
an adhesive top pad affixed to said top face;
a bottom adhesive element affixed to said bottom face;
a printed advertisement on said adhesive top pad; and
a releasable top sheet affixed onto said adhesive top pad.

2. The adhesive pad sticker of claim 1 wherein said bottom adhesive element is double sided tape.

3. The adhesive pad sticker of claim 1 wherein said bottom adhesive element is an adhesive bottom pad.

4. The adhesive pad sticker of claim 1, wherein said adhesive top pad on the top face of the substrate sheet is directly bonded to said top face.

5. The adhesive pad sticker of claim 4 wherein said bottom adhesive element is directly bonded to said bottom face of said substrate sheet.

6. The adhesive pad sticker of claim 1 further comprising:
a top releasable sheet affixed to said adhesive top pad; and
a bottom releasable sheet affixed to said bottom adhesive element.

7. The adhesive pad sticker of claim 6 wherein said top releasable sheet has a first release tab extending therefrom, and
wherein said bottom releasable sheet has a second release tab extending therefrom.

8. The adhesive pad sticker of claim 7 wherein said adhesive top pad does not extend to said perimeter edge of said substrate sheet.

9. The adhesive pad sticker of claim 1 further comprising:
a rodent trap; and
wherein said bottom adhesive element is also affixed to a top face of said rodent trap.
